(19) United States
(12) Patent Application Publication
(10) Pub. No.: US 2021/0143513 A1
(43) Pub. Date: May 13, 2021

(54) ENERGY STORAGE APPARATUS

(71) Applicant: GS Yuasa International Ltd., Kyoto-shi (JP)

(72) Inventor: Yoshimasa TOSHIOKA, Kyoto-shi, Kyoto (JP)

(21) Appl. No.: 17/253,539

(22) PCT Filed: Jun. 21, 2019
(86) PCT No.: PCT/JP2019/024688

§ 371 Date: Dec. 17, 2020

(30) Foreign Application Priority Data
Jun. 22, 2018 (JP) 2018-119008

(51) Int. Cl. H01M 50/547; H01M 50/204

(52) U.S. Cl. CPC H01M 50/547; H01M 50/567; H01M 50/204

(57) ABSTRACT

An embodiment includes at least one energy storage device, an end member arranged in a first direction with the energy storage device, and an external connection terminal fixed to the end member and forming a conduction path between an external device and the energy storage device, in which the external connection terminal has a conduction surface that conducts with the energy storage device and is fixed to the end member in a normal direction of the conduction surface.

### CROSS REFERENCE TO RELATED APPLICATIONS

This application claims the priority of Japanese Patent Application No. 2018-119008, and the content of Japanese Patent Application No. 2018-119008 is incorporated by reference into the description of the present application.

### TECHNICAL FIELD

The present invention relates to an energy storage apparatus including at least one energy storage device and an external connection terminal forming a conduction path between an external device and the energy storage device.

### BACKGROUND ART

Conventionally, a battery to which a terminal block is attached has been known (see JP-A-2016-219133). In this battery, as illustrated in FIGS. 12 and 13, an electrode post 502 is provided so as to project from an upper surface 501, and a battery terminal 510 is fixed to the electrode post 502. The battery terminal 510 is formed in a substantially rectangular parallelepiped shape. The battery terminal 510 is provided with an insertion hole 511 into which the electrode post 502 is inserted at one end, and a bolt 512 for fixing the terminal block 520 is erected at the other end.

The battery terminal 510 is fixed to the electrode post 502 by reducing the diameter of the insertion hole 511 with the electrode post 502 being inserted.

The terminal block 520 includes a circuit terminal 521 and a power supply terminal 522. At the circuit terminal 521, a terminal bolt 5211 to which a circuit is connected is erected so as to extend in a direction orthogonal to an extending direction of the electrode post 502 and the bolt 512. For example, a round terminal or the like of an electric wire with a terminal extending from the circuit is fixed to the terminal bolt 5211 by fastening a nut. The power supply terminal 522 is provided with a through hole 5221 through which the bolt 512 of the battery terminal 510 penetrates. The power supply terminal 522 is fixed to the battery terminal 510 by fastening the nut 513 onto the bolt 512 that penetrates the through hole 5221. Power from the electrode post 502 is supplied to the power supply terminal 522 via the battery terminal 510.

When the battery 500 to which the terminal block 520 is attached is in use, if the electric wire with the terminal, or the like is pulled and tension or the like in the extending direction of the terminal bolt 5211 is applied to the terminal bolt 5211, stress concentration is likely to occur at a fixing point of the terminal block 520 due to application of force in a bending direction, or the like and the fixing point is easily damaged. Note that in the examples of FIGS. 12 and 13, the fixing point means a fixing point between the terminal block 520 and the battery terminal 510, a fixing point between the battery terminal 510 and the battery 500, and more specifically, the bolt 512 and the electrode post 502.

### PRIOR ART DOCUMENT

### Patent Document

Patent Document 1: JP-A-2016-219133

### SUMMARY OF THE INVENTION

### Problems to be Solved by the Invention

Accordingly, it is an object of an embodiment to provide an energy storage apparatus in which a fixing point between an external connection terminal and an end member is not easily damaged when a force in a normal direction of a conduction surface of the external connection terminal is applied to the conduction surface.

### Means for Solving the Problems

An energy storage apparatus of an embodiment includes at least one energy storage device, an end member arranged in a first direction with the energy storage device, and an external connection terminal fixed to the end member and forming a conduction path between an external device and the energy storage device, in which the external connection terminal has a conduction surface that is a flat surface that conducts with the energy storage device and is fixed to the end member in a normal direction of the conduction surface.

### BRIEF DESCRIPTION OF THE DRAWINGS

FIG. 1 is a perspective view of an energy storage apparatus according to an embodiment.

FIG. 2 is an exploded perspective view of the energy storage apparatus.

FIG. 3 is a perspective view of an end member included in the energy storage apparatus.

FIG. 4 is a diagram illustrating a state in which an external connection terminal is arranged at a first position in the end member.

FIG. 5 is a diagram illustrating a state in which the external connection terminal is arranged at a second position in the end member.

FIG. 6 is a perspective view illustrating a connection state between the external connection terminal fixed to the end member and the energy storage device.

FIG. 7 is a perspective view of the external connection terminal and the end member in a state that an electric wire is connected.

FIG. 8 is a perspective view of the electric wire and the external connection terminal.

FIG. 9 is an exploded perspective view of the external connection terminal and the electric wire.

FIG. 10 is an enlarged view of the external connection terminal and surroundings thereof with a lid portion removed.

FIG. 11 is a diagram for explaining a conduction surface according to another embodiment.

FIG. 12 is an exploded perspective view of a terminal block and surroundings thereof in a battery to which a conventional terminal block is attached.

FIG. 13 is a cross-sectional view of the terminal block.

### MODE FOR CARRYING OUT THE INVENTION

An energy storage apparatus according to an embodiment includes at least one energy storage device, an end member arranged in a first direction with the energy storage device, and an external connection terminal fixed to the end member and forming a conduction path between an external device and the energy storage device, in which the external connection terminal has a conduction surface that conducts with the energy storage device and is fixed to the end member in a normal direction of the conduction surface.

Thus, the external connection terminal is fixed to the end member in the normal direction of the conduction surface, and when a force in the normal direction of the conduction surface is applied to the conduction surface, a force in a pulling direction is applied to the fixing point between the external connection terminal and the end member, thereby suppressing stress concentration at the fixing point.

Consequently, occurrence of damage or the like due to the stress concentration at the fixing point can be suppressed. That is, the fixing point between the external connection terminal and the end member is less likely to be damaged. Note that in the present embodiment, the external device may be another energy storage apparatus or an external load.

In the energy storage apparatus, the conduction surface may be arranged in a state that the normal direction matches the first direction at a position that overlaps with at least one of the energy storage device or the end member when viewed from the first direction.

With such a configuration, the connection position between the conduction surface of the external connection terminal and the electric wire or the like for forming the conduction path between the external device and the energy storage device fits in a region overlapping with at least one of the energy storage device or the end member when viewed from the first direction. That is, protrusion of the connection position in the direction orthogonal to the first direction is prevented. Therefore, the dimension of the energy storage apparatus in this direction (direction orthogonal to the first direction) can be restrained.

Further, in the energy storage apparatus, the end member may have conductivity, the external connection terminal may have a conductive member including the conduction surface, and an insulating member that insulates the conductive member and the end member, and the insulating member may be fixed to the end member in a state of directly or indirectly holding the conductive member.

Thus, the conductive member can be fixed to the end member by using a member in which the insulating member in a state of holding the conductive member is fixed to the end member, so as to insulate between the end member and the conductive member.

In the energy storage apparatus, the conductive member may have a first portion fixed to the energy storage device by being conductively connected to the energy storage device on one side of the end member in a second direction orthogonal to the first direction, and a second portion that extends from the first portion along the end member to another side in the second direction and includes the conduction surface, and the insulating member may be fixed to the end member on both sides of the conduction surface in a third direction orthogonal to the first direction and the second direction.

Thus, by fixing the second portion to the energy storage device and the end member at a position surrounding the conduction surface, even if a force in a direction other than the direction in which the conduction surface faces is applied to the conduction surface, damage to the fixing point between the external connection terminal and the end member or the energy storage device as well as the second portion can be suppressed.

Further, the energy storage apparatus may further include a fastening member that fixes the external connection terminal to the end member, in which the external connection terminal may have a screwing part having a screw center orthogonal to or substantially orthogonal to the conduction surface on the conduction surface, at least a part of an outer edge of the second portion may extend in a direction intersecting a virtual circle centered on the screw center, the insulating member may have an opposing portion that opposes at least a part of the outer edge and comes in contact with at least a part of the outer edge when the second portion attempts to turn or turns around the screw center, and the fastening member may fix to the end member a portion that is in the insulating member and adjacent to the opposing portion.

With such a configuration, if the second portion attempts to co-rotate when the electric wire or the like for forming a conduction path between an external device and the energy storage device is screwed with respect to the conduction surface, the co-rotation is suppressed by a part of the outer edge of the second portion, the part being at least a part of the outer edge extending in the direction intersecting the virtual circle, coming in contact with the opposing portion of the insulating member. Moreover, because the portion adjacent to the opposing portion of the insulating member is fixed to the end member by the fastening member, a displacement in a co-rotating direction of the second portion with respect to the insulating member when a force in the screwing direction is applied to the conduction surface is difficult to occur.

Further, in the energy storage apparatus, the end member may have a plurality of first fixing portions used when the external connection terminal is fixed at a first position on the end member, and a plurality of second fixing portions used when the external connection terminal is fixed at a second position different from the first position on the end member, in which a first fixing portion of a part of the plurality of first fixing portions may be common to a second fixing portion of a part of the plurality of second fixing portions.

Thus, by the first fixing portion of a part of the plurality of first fixing portions and the second fixing portion of a part of the plurality of second fixing portions being common, the number of fixing portions (first fixing portions and second fixing portions) can be suppressed while employing a configuration in which the position of the external connection terminal with respect to the end member can be changed.

From the above, according to the present embodiment, it is possible to provide an energy storage apparatus in which the fixing point between an external connection terminal and an end member is not easily damaged when a force in a normal direction of a conduction surface of the external connection terminal is applied to the conduction surface.

Hereinafter, an embodiment of the present invention will be described with reference to FIGS. 1 to 10. Note that the names of respective constituent members (respective constituent elements) of the present embodiment are for the present embodiment, and may differ from the names of the respective constituent members (respective constituent elements) in the background art.

As illustrated in FIGS. 1 and 2, the energy storage apparatus includes at least one energy storage device 2, a holding member 4 that holds the at least one energy storage device 2, and an external connection terminal 7 that forms a conduction path between an external device and the energy storage device 2. The energy storage apparatus 1 also includes a fastening member 8 that fixes the external connection terminal 7 to the holding member 4. Further, the energy storage apparatus 1 includes an adjacent member 3 adjacent to the energy storage device 2, an insulator 5 arranged between the at least one energy storage device 2 and the holding member 4, and a bus bar 6 that connects different energy storage devices 2 with each other or connects the energy storage device 2 and the external connection terminal 7 in an electrically conductive manner. The energy storage apparatus 1 of the present embodiment includes a plurality of energy storage devices 2 and a plurality of adjacent members 3, and the holding member 4 holds the plurality of energy storage devices 2 and the plurality of adjacent members 3 all together.

The plurality of energy storage devices 2 is arranged in a predetermined direction. Each of these plurality of energy storage devices 2 is a primary battery, a secondary battery, a capacitor, or the like. The energy storage device 2 of the present embodiment is a nonaqueous electrolyte secondary battery that can be charged and discharged. More specifically, the energy storage device 2 is a lithium ion secondary battery that utilizes electron transfer generated by movement of lithium ions. This energy storage device 2 is what is called a prismatic lithium ion secondary battery.

Each of the plurality of energy storage devices 2 has an electrode assembly, a case 21 that accommodates the electrode assembly together with an electrolyte solution, and a terminal 22 at least a part of which is exposed to the outside of the case 21.

The case 21 has a case main body 211 having an opening, and a plate-shaped lid plate 216 that blocks (closes) the opening of the case main body 211. The case main body 211 of the present embodiment has a bottomed square tubular shape. The case 21 has a flat rectangular parallelepiped shape. The case main body 211 includes a rectangular plate-shaped closed portion 212 and a tubular body portion (peripheral wall) 213 connected to a peripheral edge of the closed portion 212. The body portion 213 has a flat square tubular shape. The body portion 213 has a pair of long wall parts 214 extending from long sides at the peripheral edge of the closed portion 212, and a pair of short wall parts 215 extending from short sides at the peripheral edge of the closed portion 212. By connecting corresponding ends of the pair of long wall parts 214 to each other by the short wall parts 215, the flat square tubular body portion 213 is formed. The lid plate 216 is a rectangular plate-shaped member that closes the opening of the case main body 211. A pair of terminals 22 is arranged on the lid plate 216.

In the energy storage apparatus 1 of the present embodiment, the plurality of energy storage devices 2 is arranged in a state that the long wall parts 214 of the case 21 (case main body 211) oppose each other.

Hereinafter, a direction in which the plurality of energy storage devices 2 is lined up (first direction) is defined as X-axis of a Cartesian coordinate system, a direction in which the short wall parts 215 of the case main body 211 oppose each other (third direction) is defined as Y-axis of the Cartesian coordinate system, and a direction in which the closed portion 212 and the lid plate 216 oppose each other (second direction) is defined as Z-axis of the Cartesian coordinate system.

The adjacent member 3 is arranged between two energy storage devices 2 arranged in the X-axis direction, or between the endmost energy storage device 2 in the X-axis direction and a member aligned with the energy storage device 2 in the X-axis direction (a part of the holding member 4 in the example of the present embodiment).

The adjacent member 3 is constituted of a member having an insulating property such as resin. Further, the adjacent member 3 forms a flow path through which a fluid for adjusting the temperature of the energy storage device 2 can flow between the adjacent member 3 and the energy storage device 2.

The holding member 4 holds the plurality of energy storage devices 2 and the plurality of adjacent members 3 all together by surrounding the periphery of the plurality of energy storage devices 2 and the plurality of adjacent members 3. The holding member 4 is made of a member with conductivity such as metal. Further, the holding member 4 has an end member 40 which is aligned with the energy storage device 2. Specifically, the holding member 4 has a pair of end members 40 arranged on both sides of the plurality of energy storage devices 2 in the X-axis direction, and a connecting member 43 interconnecting ends in the Y-axis direction in the end members 40. Further, the holding member 4 has a fixing member 45 that fixes (connects) the end member 40 and the connecting member 43. The fixing member 45 of the present embodiment includes a bolt 451 and a nut 452. In the energy storage apparatus 1 of the present embodiment, the pair of connecting members 43 interconnects the ends on both sides in the Y-axis direction in the pair of end members 40.

Each of the pair of end members 40 is arranged in a state that the adjacent member 3 is sandwiched between the end member 40 and the energy storage device 2 arranged at an end in the X-axis direction. As illustrated in FIG. 3, each of these pair of end members 40 has an end member main body 41 that is a portion extending along a Y-Z plane (plane including the Y-axis and the Z-axis) and overlapping with the energy storage device 2 when viewed from the X-axis direction, and an extension portion 42 extending from the end member main body 41.

The end member main body 41 is a rectangular part corresponding to the energy storage device 2 when viewed from the X-axis direction. As illustrated in FIGS. 4 and 5, the external connection terminal 7 is fixed (attached) to the end member main body 41. The end member main body 41 of the present embodiment can fix (mount) the external connection terminal 7 at a plurality of different positions. Specifically, the end member main body 41 can fix the external connection terminal 7 at a first position on one side in the Y-axis direction (see FIG. 4) or a second position on the other side in the Y-axis direction (see FIG. 5) at an end on one side in the Z-axis direction (upper side in FIGS. 4 and 5). Note that in FIGS. 4 and 5, the external connection terminal 7 with the lid portion 75 removed (see FIG. 1) is illustrated.

For fixing the external connection terminal 7 to the end member main body 41, a fixing portion 411 provided in the end member main body 41 is used. The fixing portion 411 of the present embodiment is a hole provided in the end member main body 41 and through which the fastening member 8 is inserted. The end member main body 41 has a plurality of the fixing portions 411.

Specifically, the end member main body 41 has a plurality of (two in the example of the present embodiment) first fixing portions 411A used when the external connection terminal 7 is fixed at the first position, and a plurality of (two in the example of the present embodiment) second fixing portions 411B used when the external connection terminal 7 is fixed at the second position. Then, the first fixing portion 411A of a part of the plurality of first fixing portions 411A and the second fixing portion 411B of a part of the plurality of second fixing portions 411B are common (see FIG. 3).

In the end member main body 41 of the present embodiment, two first fixing portions 411A are spaced apart in the Y-axis direction on one side in the Z-axis direction, and two second fixing portions 411B are spaced apart in the Y-axis direction. Then, the first fixing portion 411A on the center side in the Y-axis direction of the two first fixing portions 411A and the second fixing portion 411B on the center side in the Y-axis direction of the two second fixing portions 411B are a common hole. The common hole 411A, 411B is an elongated hole whose diameter in the Y-axis direction is larger than the diameter in the Z-axis direction, and the remaining first fixing portion 411A and second fixing portion 411B (outside in the Y-axis direction) are circular holes having the same diameters in the Y-axis direction and the Z-axis direction.

The extension portion 42 is a portion extending from a side 41A corresponding to the closed portion 212 of the energy storage device 2 in the rectangular end member main body 41. The extension portion 42 is used to fix the energy storage apparatus 1 to the installation surface. The end member 40 of the present embodiment has two extension portions 42 that are spaced apart in the Y-axis direction.

As illustrated in FIGS. 1 and 2, the pair of connecting members 43 is arranged on both sides of the plurality of energy storage devices 2 in the Y-axis direction. Each of the pair of connecting members 43 has a connecting member main body 431 extending in the X-axis direction along the respective short wall parts 215 of the plurality of energy storage devices 2, a first extension portion 432 extending along the Y-axis direction from an end of the other side (lower side in FIGS. 1 and 2) in the Z-axis direction of the connecting member main body 431 (extending along the closed portion 212 of each of the plurality of energy storage devices 2), and a second extension portion 433 extending from the first extension portion 432 to the other side in the Z-axis direction. Further, each of the pair of connecting members 43 has a connected part 434 extending in the Y-axis direction from an end of the connecting member main body 431 in the X-axis direction along a surface of the end member 40 facing outward in the X-axis direction. The connecting member 43 of the present embodiment has connected parts 434 at both ends in the X-axis direction. That is, each of the pair of connecting members 43 has a pair of connected parts 434.

In the energy storage apparatus 1 of the present embodiment, in a state that the bolts 451 constituting the fixing member 45 are inserted through the connected parts 434 of the connecting member 43 and the ends of the end member 40 in the Y-axis direction, the bolts 451 are screwed with the nuts 452 arranged on a surface (inside in the X-axis direction) on the energy storage device 2 side of the end member main body 41. Thus, the connecting member 43 and the end member 40 are connected (fixed).

The insulator 5 has an insulating property and is arranged between the connecting member 43 and the plurality of energy storage devices 2. The insulator 5 covers a region of the connecting member 43 opposing at least the plurality of energy storage devices 2. Specifically, the insulator 5 of the present embodiment at least covers a surface of the connecting member main body 431 facing each energy storage device 2, a surface of the first extension portion 432 facing each energy storage device 2, and a surface of the second extension portion 433 facing inward in the Y-axis direction. Thus, the insulator 5 insulates between the connecting member 43 and the plurality of energy storage devices 2.

The bus bar 6 is a plate-shaped member having conductivity of metal or the like. The bus bar 6 conducts the terminals 22 of different energy storage devices 2 to conduct each other or the terminals 22 of the energy storage devices 2 and the external connection terminal 7. A plurality of bus bars 6 is provided in the energy storage apparatus 1 (the number corresponding to the number of the plurality of energy storage devices 2 and the number of external connection terminals 7). The plurality of bus bars 6 of the present embodiment connect (conduct) all of the plurality of energy storage devices 2 included in the energy storage apparatus 1 in series. The bus bars 6 of the present embodiment include one having a plate shape along the X-Y plane (a plane including the X-axis and the Y-axis) and one having a portion that is curved or bent so as to project toward one side in the Z-axis direction at an intermediate position in the X-axis direction, but in each case, the contour shape seen from the Z-axis direction is rectangular.

The external connection terminal 7 is what is called a terminal block, and is fixed (connected) to the end member 40. As illustrated in FIGS. 4 to 10, this external connection terminal 7 has a conduction surface 722A that conducts with at least one energy storage device 2, and is fixed to the end member 40 in a normal direction of the conduction surface 722A (X-axis direction in the example of the present embodiment). In the energy storage apparatus 1 of the present embodiment, the external connection terminals 7 are fixed to each of the pair of end members 40. That is, the energy storage apparatus 1 includes a pair of external connection terminals 7.

Specifically, each of the pair of external connection terminals 7 has a conductive member 70 including the conduction surface 722A on a surface, and a base (insulating member) 73 that holds the conductive member 70.

The conductive member 70 has a conductor first portion 71 fixed to the energy storage device 2 by being conductively connected to the energy storage device 2, and a conductor second portion 72 extending from the conductor first portion 71 along the end member 40.

The conductor first portion 71 is a portion conductively connected to the terminal 22 of the energy storage device 2 arranged on the outermost side in the X-axis direction by the bus bar 6 (see FIGS. 6 and 8). The conductor first portion 71 is arranged on one side in the Z-axis direction with respect to the end member 40, and the bus bar 6 is connected (welded in the example of the present embodiment) thereto. The conductor first portion 71 of the present embodiment is a rectangular plate-shaped portion spreading along the X-Y plane.

The conductor second portion 72 has an input-output part 721 to which an electric wire or the like (in the example of the present embodiment, an electric wire 90 having an O terminal 91 attached to the tip: see FIGS. 8 and 9) is connected, and an extension portion 725 extending from the input-output part 721 to the conductor first portion.

The input-output part 721 has a main body 722 including a conduction surface 722A, and a screwing part 723 having a screw center C orthogonal or substantially orthogonal to the conduction surface 722A. The screwing part 723 of the present embodiment extends in the screw center C direction. Furthermore, the screw center C direction of the present embodiment matches the X-axis direction.

The main body 722 is a plate-shaped portion spreading along the end member 40 (Y-Z plane). At least a part of an outer edge of the main body 722 extends in a direction intersecting a virtual circle Vc centered on the screw center C (see FIG. 10). The main body 722 of the present embodiment is a polygon when viewed from the X-axis direction (in the example of the present embodiment, it is a polygon having a corner that projects outward and a corner that is recessed inward), and each side (part of the outer edge) 7221 of the polygon extends in a direction intersecting the virtual circle Vc. Note that the virtual circle Vc is a circle having an arbitrary diameter, and is a virtual circle for determining, when having a diameter of a size that overlaps (corresponds to) a part of the outer edge of the main body 722 (a portion to be determined whether or not to intersect with the virtual circle Vc), whether or not the virtual circle Vc and the part of the outer edge intersect with each other.

In the main body 722 of the present embodiment, a surface facing the outside in the X-axis direction (a side opposite to the side of the end member 40) is the conduction surface 722A. The conduction surface 722A faces the X-axis direction at a position overlapping with at least one of the energy storage device 2 or the end member 40 when viewed from the X-axis direction. The conduction surface 722A of the present embodiment faces the X-axis direction at a position overlapping with both the energy storage device 2 and the end member 40 when viewed from the X-axis direction.

The screwing part 723 is a part that extends from the main body 722 and to which a nut 92 is screwed when the O terminal 91 attached to the tip of the electric wire 90 is connected to the conduction surface 722A (see FIGS. 8 and 9). The screwing part 723 of the present embodiment is a bolt part extending from the central portion of the conduction surface 722A in the normal direction of the conduction surface 722A (the X-axis direction in the example of the present embodiment) and having a male screw on a peripheral surface.

The base 73 has an insulating property, and is arranged between the conductive member 70 and the end member 40 to insulate between the conductive member 70 and the end member 40. The base 73 is fixed to the end member 40 in a state of directly or indirectly holding the conductive member 70. Specifically, the base 73 has a base main body 74 that holds the conductive member 70, and a lid portion 75 that covers the screwing part 723 and the conduction surface 722A so as to be openable and closable.

The base main body 74 has an insulating first portion 77 that holds the conductor first portion 71 of the conductive member 70, and an insulating second portion 78 that holds the conductor second portion of the conductive member 70. Further, the base main body 74 also has a fixing portion 79 through which a fastening member (fixing member) 8 is inserted in order to fix the base main body 74 to the end member 40.

The insulating first portion 77 has a plate-shaped part 771 spreading along the conductor first portion 71 (X-Y plane) between the conductor first portion 71 and the end member 40, and a wall part 772 extending on one side in the Z-axis direction from the plate-shaped part 771 and extending along three sides excluding a portion (side) on the energy storage device 2 side of the peripheral edges (four sides) of the conductor first portion 71.

The insulating second portion 78 has a covering portion 781 that covers the extension portion 725 and a peripheral wall part 782 that extends in the X-axis direction at a position surrounding the input-output part 721 (main body 722).

The covering portion 781 covers the entire extension portion 725 between the insulating first portion 77 and the peripheral wall part 782.

The peripheral wall part 782 holds the main body 722 by embedding at least a part of a peripheral edge portion of the main body 722. The peripheral wall part 782 has a first portion 782A having a smaller dimension in the X-axis direction and a second portion 782B having a larger dimension in the X-axis direction than the first portion 782A. In the peripheral wall part 782, a part on a tip end side (part including the tip end) of the second portion 782B protrudes outward in the X-axis direction from the first portion 782A (the tip end of the first portion 782A). That is, at the boundary position between the first portion 782A and the second portion 782B, a step 783 extending in the X-axis direction is formed between a tip of the first portion 782A and a tip of the second portion 782B.

The peripheral wall part 782 has an opposing portion 7821 that opposes at least a part of the outer edge of the conductor second portion 72, and comes in contact with at least a part of the outer edge when the conductor second portion 72 attempts to turn or turns around the screw center C (see FIG. 10). The opposing portion 7821 is each portion that each of a plurality of sides (part of the outer edge) 7221 constituting the outer edge of the main body 722 opposes in a state that at least a part of the peripheral edge portion of the main body 722 is embedded in the peripheral wall part 782. That is, the peripheral wall part 782 of the present embodiment has a plurality of the opposing portions 7821 (the number corresponding to each side 7221 extending in a direction intersecting the virtual circle Vc centered on the screw center C).

The fixing portion 79 extends from the base main body 74 along the end member 40 and has a hole 791 through which the fastening member 8 is inserted (see FIGS. 8 and 9). This hole 791 is arranged in a region adjacent to the outer edge of the main body 722 of the conductor second portion 72 (specifically, the side 7221 opposing the opposing portion 7821 of the peripheral wall part 782) when viewed in the X-axis direction (see FIG. 10). The fixing portion 79 of the present embodiment extends from the peripheral wall part 782 so that the holes 791 are located on both sides of the conduction surface 722A in the Y-axis direction. That is, the fixing portion 79 extends from the peripheral wall part 782 to one side and the other side in the Y-axis direction.

The plurality of holes 791 (two in the example of the present embodiment) is arranged at the positions surrounding the main body 722 (positions surrounding the main body 722 when viewed from the X-axis direction) together with the conductor first portion 71 fixed to the energy storage device 2 with the bus bar 6 interposed therebetween. In the fixing portion 79 of the present embodiment, the two holes 791 are arranged on both sides of the conduction surface 722A in the Y-axis direction and on the other side (lower side in FIG. 10) in the Z-axis direction from the screw center C of the screwing part 723. Further, the two holes 791 of these fixing portions 79 overlap with the two first fixing portions 411A provided on the end member main body 41 when the external connection terminal 7 is fixed at the first position, and overlap with the second fixing portion 411B provided on the end member main body 41 when the external connection terminals 7 is fixed at the second position.

The lid portion 75 is connected to an end (step 783) of the second portion 782B, and can turn around a virtual center line V1 extending in the X-axis direction at the connection position. The lid portion 75 is turnable between a closed position (see FIG. 8) in which the conduction surface 722A and the screwing part 723 are covered when viewed from the X-axis direction, and an open position (see FIG. 9) in which the conduction surface 722A and the screwing part 723 are exposed when viewed from the X-axis direction.

Note that in the external connection terminal 7 of the present embodiment, an arrangement region of the electric wire 90 is open even when the lid portion 75 is in the closed position. That is, even when the lid portion 75 is in the closed position, a space S1 surrounded by the peripheral wall part 782 and the lid portion 75 and an outside space S are in communication through the arrangement region (see FIG. 8).

The electric wire 90 with the O terminal 91 is connected to the external connection terminal 7 configured as described above. Specifically, first, the lid portion 75 is turned from the closed position to the open position. Subsequently, the screwing part 723 is inserted into the O terminal 91 until the O terminal 91 comes into surface contact with the conduction surface 722A, and the nut 92 is screwed onto the screwing part 723 in a state that the O terminal 91 is inserted. When the nut 92 is sufficiently fastened, the lid portion 75 is subsequently turned from the open position to the closed position, thereby completing connection of the electric wire 90 to the energy storage apparatus 1 (external connection terminal 7). On the other hand, removal of the electric wire 90 from the energy storage apparatus 1 is performed in the reverse procedure.

The fastening member 8 is inserted into the fixing portion (hole) 411 of the end member 40 (end member main body 41) and the hole 791 of the external connection terminal 7 (fixing portion 79), and in this state, the end member 40 and the external connection terminal 7 are fastened. Thus, the external connection terminal 7 is fixed to the end member 40 in the X-axis direction (the direction in which the fastening member 8 is inserted through the external connection terminal 7 and the end member 40). The fastening member 8 of the present embodiment is, for example, a rivet.

In the above energy storage apparatus 1, the external connection terminal 7 is fixed to the end member 40 in the normal direction of the conduction surface 722A, and when a force in the normal direction of the conduction surface 722A (in the X-axis direction in the example of the present embodiment) is applied to the conduction surface 722A, a force in the pulling direction is applied to the fixing point between the external connection terminal 7 and the end member 40 to suppress stress concentration at the fixing point. Thus, occurrence of damage or the like due to stress concentration at the fixing point can be suppressed. That is, by preventing a force in the bending direction from being applied to the fixing point and preventing occurrence of stress concentration due to the force in the bending direction, damage to the fixing point between the external connection terminal 7 and the end member 40 is prevented.

Further, in the energy storage apparatus 1 of the present embodiment, at a position where the conduction surface 722A of the conductor second portion 72 overlaps with at least one of at least one energy storage device 2 or the end member 40 when viewed from the X-axis direction, the normal direction of the conduction surface 722A matches the X-axis direction. Thus, the connection position between the conduction surface 722A of the external connection terminal 7 and the electric wire 90 for forming the conduction path between the external device and the energy storage device 2 fits in a region overlapping with at least one of the energy storage device 2 or the end member 40 when viewed from the X-axis direction. That is, protrusion of the connection position in the direction orthogonal to the X-axis direction (Y-Z plane direction) is prevented, thereby restraining the dimension of the energy storage apparatus 1 in this direction (direction orthogonal to the X-axis direction).

Further, in the energy storage apparatus 1 of the present embodiment, the base (insulating member) 73 in a state of holding the conductive member 70 is fixed to the end member 40, that is, the conductive member 70 is fixed to the end member 40 by using a member for the purpose of insulation between the end member 40 and the conductive member 70.

Further, in the energy storage apparatus 1 of the present embodiment, the conductor first portion 71 is connected to the energy storage device 2 via the bus bar 6 on one side of the end member 40 in the Z-axis direction. Further, the base 73 is fixed to the end member 40 on both sides of the conduction surface 722A in the Y-axis direction. Thus, by fixing the conductor second portion 72 to the energy storage device 2 and the end member 40 at the position surrounding the conduction surface 722A, even if a force in a direction other than the normal direction (X-axis direction) of the conduction surface 722A is applied to the conduction surface 722A, damage to the fixing point between the external connection terminal 7 and the end member 40 or the energy storage device 2 as well as the conductor second portion 72 can be suppressed.

Further, in the energy storage apparatus 1 of the present embodiment, at least a part of the outer edge of the insulating second portion 78 (the side 7221 of the main body 722 in the present embodiment) extends in a direction to intersect the virtual circle Vc centered on the screw center C. Further, the peripheral wall part 782 of the base 73 has the opposing portion 7821 that opposes at least a part (side 7221) of the outer edge, and comes in contact with at least a part (side 7221) of the outer edge when the insulating second portion 78 attempts to turn or turns around the screw center C. Thus, when fixing the electric wire 90 for input to or output from the outside to the conduction surface 722A (main body 722), if the conductor second portion 72 attempts to co-rotate due to screwing and fastening the nut 92 onto the screwing part 723, the co-rotation is suppressed by a part of the outer edge of the conductor second portion 72 (at least a part 7221 of the outer edge extending in the direction intersecting the virtual circle Vc) coming in contact with the opposing portion 7821 of the base 73.

Moreover, because the portion (fixing portion 79) adjacent to the opposing portion 7821 of the base 73 is fixed to the end member 40 by the fastening member 8, the opposing portion 7821 is hard to move when a force in the screwing direction is applied to the conduction surface 722A (conductor second portion 72). Thus, deviation of the conductor second portion 72 with respect to the base 73 (deviation in the co-rotating direction) is unlikely to occur.

Further, in the energy storage apparatus 1 of the present embodiment, in the end member 40, the first fixing portion 411A of a part of the plurality of first fixing portions 411A is common with the second fixing portion 411B of a part of the plurality of second fixing portions 411B. Thus, by the first fixing portion 411A of a part of the plurality of first fixing portions 411A and the second fixing portion 411B of a part of the plurality of second fixing portions 411B being common, the number of fixing portions 411 (first fixing portion 411A and second fixing portion 411B) can be suppressed while employing a configuration in which the position of the external connection terminal 7 with respect to the end member 40 can be changed.

Note that the energy storage apparatus according to the present invention is not limited to the above-described embodiment, and it goes without saying that various modifications can be made without departing from the gist of the present invention. For example, a configuration of one embodiment can be added to configurations of another embodiment, and a part of configurations of one embodiment can be replaced with a configuration of another embodiment. Moreover, some of the configurations of certain embodiments can be deleted.

The specific direction which the normal direction of the conduction surface 722A of the external connection terminal 7 matches is not limited. The normal direction of the conduction surface 722A may match the Y-axis direction or may match the Z-axis direction. Further, the normal direction of the conduction surface 722A may match a direction other than each axial direction of the Cartesian coordinate system illustrated in FIG. 1 and the like. Even if the normal direction of the conduction surface 722A matches any direction, it is only required that the external connection terminal 7 is fixed to the end member 40 in the normal direction of the conduction surface 722A.

In the energy storage apparatus 1 of the above embodiment, the conduction surface 722A is constituted of a main surface of the flat plate-shaped member (main body 722), but the present invention is not limited to this configuration. For example, the conduction surface 722A may be constituted of a surface facing the outside (side opposite to the side of the member 70A) of the nut (screwing member) N attached by welding or the like to the member 70A (the conductive member 70 in the example of the above embodiment) conducting with the terminal 22 of the energy storage device 2, as illustrated in FIG. 11. In this configuration, the O terminal 91 or the like at the tip of the electric wire 90 is fixed (connected) to the conduction surface 722A by a member having a male screw, such as a bolt.

Further, in the energy storage apparatus 1 of the above embodiment, the input-output part 721 of the conductive member 70 has the screwing part 723, and the screwing part 723 is used to detachably connect the electric wire 90 to the external connection terminal 7, but it is not limited to this configuration. For example, a configuration may be employed in which the electric wire 90 or the like is connected (fixed) to the conduction surface 722A by welding or the like, without providing screwing parts such as bolts and nuts on the conductive member 70.

Further, the specific position of the conduction surface 722A in the energy storage apparatus 1 is not limited. For example, in the energy storage apparatus 1 of the above embodiment, the conduction surface 722A is arranged at a position that overlaps with the end member 40 when viewed from the X-axis direction, but may be arranged at a position that does not overlap therewith.

Further, in the energy storage apparatus 1 of the above embodiment, the fastening member 8 for fixing the external connection terminal 7 to the end member 40 is a rivet, but it is not limited to this configuration. For example, the fastening member 8 may be a bolt and a nut, a blind rivet, or the like. Further, fixing of the external connection terminal 7 to the end member 40 may be performed by welding, adhesion, or the like without using the fastening member 8. Further, the base 73 of the external connection terminal 7 may have a projecting portion at a position corresponding to the fixing portion 411 of the end member 40, and the projecting portion may be inserted (fitted) into the fixing portion 411 to thereby fix the external connection terminal 7 to the end member 40.

Further, the fixing point between the external connection terminal 7 and the end member 40 (in the example of the above embodiment, the number of fastening members 8) is not limited to two. The number of the fixing points may be one or three or more.

Further, in the external connection terminal 7 of the above embodiment, in order to prevent co-rotation of the conductor second portion 72 (main body 722) when the nut 92 is screwed onto the screwing part 723 and fastened to connect the electric wire 90, a plurality of sides 7221 extending in the direction intersecting the virtual circle Vc centered on the screw center C is provided on the outer edge of the conductor second portion 72, and a plurality (the number corresponding to the sides 7221) of opposing portions 7821 opposing each side 7221 is provided on the base main body 74, but it is not limited to this configuration. A configuration may be employed in which only one set of the side 7221 of the conductor second portion 72 and the opposing portion 7821 of the base main body 74 corresponding to the side 7221 is provided in the external connection terminal 7. Also with such a configuration, co-rotation when the nut 92 or the like is fastened upon connecting the electric wire 90 to the external connection terminal 7 can be prevented.

Further, in the external connection terminal 7 of the above embodiment, the side 7221 of the conductor second portion 72 and the opposing portion (opposing portion of the base main body 74) 7821 opposing the side 7221 are in contact with each other, but it is not limited to this configuration. A gap may be provided between the side 7221 of the conductor second portion 72 and the opposing portion 7821 of the base main body 74. In this case, when connecting the electric wire 90 or the like to the external connection terminal 7, if the conductor second portion 72 co-rotates by fastening the bolt or the nut, the configuration (the gap) is only required such that the side 7221 of the conductor second portion 72 after having co-rotated by a predetermined amount comes in contact with the opposing portion 7821 of the base main body 74, thereby suppressing further co-rotation.

Further, in the energy storage apparatus 1 of the above embodiment, the first fixing portion 411A of a part of the plurality of first fixing portions 411A and the second fixing portion 411B of a part of the plurality of second fixing portions 411B that are used when fixing the external connection terminal 7 to the end member 40 are common, but it is not limited to this configuration. The plurality of first fixing portions 411A and the plurality of second fixing portions 411B do not need to have a common fixing portion (hole 411 in the example of the above embodiment). Further, the fixed position of the external connection terminal 7 may be one in the end member 40.

1. An energy storage apparatus comprising:
at least one energy storage device;
an end member arranged in a first direction with the energy storage device; and
an external connection terminal fixed to the end member and forming a conduction path between an external device and the energy storage device,
wherein the external connection terminal has a conduction surface that conducts with the energy storage device and the external connection terminal is fixed to the end member in a normal direction of the conduction surface.

2. The energy storage apparatus according to claim 1, wherein the conduction surface is arranged in a state that the normal direction matches the first direction at a position that overlaps with at least one of the energy storage device or the end member when viewed from the first direction.

3. The energy storage apparatus according to claim 1, wherein
the end member has conductivity,
the external connection terminal has:
a conductive member including the conduction surface; and
an insulating member that insulates the conductive member and the end member, and
the insulating member is fixed to the end member in a state of directly or indirectly holding the conductive member.

4. The energy storage apparatus according to claim 3, wherein
the conductive member has:
a first portion fixed to the energy storage device by being conductively connected to the energy storage device on one side of the end member in a second direction orthogonal to the first direction; and
a second portion that extends from the first portion along the end member to another side in the second direction and includes the conduction surface, and
the insulating member is fixed to the end member on both sides of the conduction surface in a third direction orthogonal to the first direction and the second direction.

5. The energy storage apparatus according to claim 4, further comprising a fastening member that fixes the external connection terminal to the end member,
wherein the external connection terminal has a screwing part having a screw center orthogonal to or substantially orthogonal to the conduction surface on the conduction surface,
at least a part of an outer edge of the second portion extends in a direction intersecting a virtual circle centered on the screw center,
the insulating member has an opposing portion that opposes at least a part of the outer edge and comes in contact with at least a part of the outer edge when the second portion attempts to turn or turns around the screw center, and
the fastening member fixes to the end member a portion that is in the insulating member and adjacent to the opposing portion.

6. The energy storage apparatus according to claim 1, wherein
the end member has:
a plurality of first fixing portions used when the external connection terminal is fixed at a first position on the end member; and
a plurality of second fixing portions used when the external connection terminal is fixed at a second position different from the first position on the end member,
wherein a first fixing portion of a part of the plurality of first fixing portions is common to a second fixing portion of a part of the plurality of second fixing portions.
